(19) United States
(12) Patent Application Publication
(10) Pub. No.: US 2026/0015809 A1
(43) Pub. Date: Jan. 15, 2026

(54) FISHWAY WITH A POOL HEAD AND A POOL TAIL

(71) Applicant: Changsha Hetong Ecological Environment Technology Co., Ltd, Changsha (CN)

(72) Inventors: Xiaoping LIU, Changsha (CN); Yasi YE, Changsha (CN); Qiankai ZHOU, Changsha (CN); Zixuan CHEN, Changsha (CN); Jiawei XU, Changsha (CN); Lu XIA, Changsha (CN); Yuyuan TANG, Changsha (CN); Erbin XIAO, Changsha (CN); Jiaqiang ZHANG, Changsha (CN); Yating LIU, Changsha (CN); Yuqing LIU, Changsha (CN)

(73) Assignee: Changsha Hetong Ecological Environment Technology Co., Ltd, Changsha (CN)

(21) Appl. No.: 19/266,212

(22) Filed: Jul. 11, 2025

(30) Foreign Application Priority Data
Jul. 11, 2024 (CN) 2024109306586

(51) Int. Cl. E02B 8/08; A01K 63/00

(52) U.S. Cl. CPC E02B 8/085; A01K 63/00

(57) ABSTRACT

The present application discloses a fishway with a pool head and pool tail in the field of fishway technology. The fishway includes a pool head, a main fishway, and a pool tail arranged sequentially from an upstream to a downstream. The main function of the pool head and the pool tail is to adapt to the fluctuation of the upstream and downstream water levels, so as to avoid the impact of the upstream and downstream water level changes on the main fishway. To achieve the above purpose, an upstream maintenance gate, a double-gate and dual-control working gate (dual control refers to flow control and fish passage effect control), an upstream steep-slope fishway, and fish guiding facilities are set at the pool head. A downstream steep-slope fishway, a water replenishment channel, and a downstream maintenance gate are set at the pool tail.

### CROSS-REFERENCE TO RELATED APPLICATIONS

This application claims priority to Chinese Patent Application No. 202410930658.6 filed on Jul. 11, 2024, entitled “fishway with a pool head and a pool tail”, in China National Intellectual Property Administration, the contents of which are incorporated by reference herein.

### TECHNICAL FIELD

The present application relates to a field of fishway engineering technology, and particularly to a fishway with a pool head and a pool tail.

### BACKGROUND

In a design of hub fishway in the prior art, it is necessary to select reasonable hydrological conditions of the hub as parameters for fishway design based on the operation of hydraulic structures (power stations, sluice gates, etc.), and set up gates at the entrance and exit of the fishway. Currently, most domestic and international fishways have gates installed at the entrances and exits of the fishway. The exit gates not only function during flood control and maintenance, but theoretically can also be opened to different degrees according to the changes of the upstream water level to regulate the flow and the water depth of the fishway. However, due to a failure to properly address an issue of simultaneous water flow and fish passage at the gates (both enabling flow control and ensuring suitable fish-passage flow conditions) in domestic and international hub fishways, when the water retention height of the gate is relatively high and the gates are partially opened, localized high flow velocities or chaotic water flow conditions can easily occur, seriously affecting fish passage effectiveness. When gates are fully open during fishway operation, the longitudinal structural dimensions of the fishway are determined by the upstream water level variations and downstream water level variations. Different hydrological conditions result in different fishway structures, making the design and the construction of the fishway complex and making standardization difficult to achieve.

In view of this, it is necessary to develop a fishway with a pool head and a pool tail to solve or at least partially alleviate the above technical problems.

### SUMMARY

The fishway with a pool head and a pool tail provided by the present application solves the technical problems in existing hub fishways, where the dimensional design heavily depends on hydrological conditions, making it difficult to balance flow regulation with ensuring suitable fish passage conditions and achieve standardized fishway construction.

To achieve the above objective, the present application adopts the following technical solution.

A fishway with pool head and pool tail comprises a main fishway, a pool head located at an upstream of water flow of the main fishway, and a pool tail located at a downstream of the water flow of the main fishway. The pool head is equipped with an upstream maintenance gate, and a dual-control working gate is arranged at a downstream of the upstream maintenance gate, a first branch channel and a second branch channel are arranged separately below the dual-control working gate. A water inlet of the first branch channel and a water inlet of the second branch channel are connected at a downstream of the dual-control working gate, and a water outlet of the first branch channel and a water outlet of the second branch channel are respectively connected to the main fishway. The dual-control working gate comprises a first gate, a fixed gate and a movable gate, the first gate for regulating flow of the first branch channel is arranged at a water inlet of the first branch channel, the fixed gate and the movable gate are arranged at a water inlet of the second branch channel, an upstream steep-slope fishway is arranged in the second branch channel, a sliding hinge support point at a bottom of the upstream steep-slope fishway is supported on a bottom surface of the second branch channel, a head portion of the upstream steep-slope fishway is connected to the movable gate, and the dual-control working gate further comprises a driving mechanism, an upper end of the upstream steep-slope fishway drives the movable gate to lift and position through the driving mechanism, thereby adjusting an inclination angle of the upstream steep-slope fishway in the second branch channel and adjusting an inflow rate of a head portion of the upstream steep-slope fishway, while cooperating with the fixed gate to seal a lower portion of the upstream steep-slope fishway. The pool tail comprises a downstream steep-slope fishway, and a downstream maintenance gate is arranged at a tail portion of the downstream steep-slope fishway.

Furthermore, the downstream maintenance gate is arranged in the pool tail, a third branch channel and a fourth branch channel are arranged at an upstream of the downstream maintenance gate, a water inlet of the third branch channel and a water inlet of the fourth branch channel are connected at the main fishway, and a water outlet of the third branch channel and a water outlet of the fourth branch channel are connected with the upstream of the downstream maintenance gate, a flow control gate for controlling flow of the third branch channel is arranged at the water inlet of the third branch channel, and the downstream steep-slope fishway is arranged in the fourth branch channel.

Furthermore, a water-passing profile of the upstream steep-slope fishway comprises a rectangular opening cross section and a converging opening section located at a lower portion of the rectangular opening cross section.

Furthermore, a fish barrier screen is arranged at the outlet of the first branch channel.

Furthermore, a fish guiding cylinder group is arranged at a fishway inlet of the second branch channel, and two groups of the fish guiding cylinder groups are arranged oppositely on both sides of the second branch channel, and the fish guiding cylinder group comprises a plurality of spoiler columns arranged at intervals along an extending direction of the second branch channel; the sliding hinge support point at the bottom of the upstream steep-slope fishway falls on the bottom surface of the second branch channel, and a hinge support axis of the upstream steep-slope fishway is located at an upstream of the fish guiding cylinder group.

The present application also provides a method for fish passing through the fishway, comprising the following steps: determining an optimal fish-passage water depth range for target fish; adjusting a water flow of a first branch channel and an upstream steep-slope fishway according to an upstream water level to maintain a fish-passage water depth of the main fishway and the upstream steep-slope fishway within the optimal fish-passage water depth range, thereby improving the fish passage efficiency of the fishway.

The present application has the following advantageous effects.

By adapting the upstream and downstream water level variations of a river through the pool head and the pool tail, the impact of upstream and downstream water level changes on the main fishway is avoided, making the structure of the main fishway, which is the most important part of the fishway and accounts for the largest amount of engineering work, no longer complicated, thus making it possible to standardize the design and construction of the main fishway, greatly saving engineering work and cost, and meeting the requirements of green environmental protection.

An upstream maintenance gate, a double-gate and double-control working gate (dual control refers to flow control and fish passage effect control), an upstream steep-slope fishway, and fish guiding facilities are set at the pool head. Through the flow regulation function at pool the head, the water depth of the main fishway can be kept within the optimal fish-passage depth range, thereby improving the fish passing efficiency of the fishway. A downstream steep-slope fishway, a water replenishment flow channel, and a downstream maintenance gate are set at the pool tail, which have the functions of adapting to the changes in the downstream water level and guiding fish to swim upstream. Through the adaptation of the pool head and the pool tail to the external hydrological conditions and the regulation and control of the flow of the main fishway, the pool water depth of the main fishway is controlled within the optimal fish-passage depth range, and the longitudinal consistency of the size of the main fishway chamber is also maintained. The present invention lays the foundation for the further implementation of smart fishways.

In addition to the objectives, features, and advantages described above, the present application has other objectives, features, and advantages. A more detailed description of the present application will be given below with reference to the drawings.

### BRIEF DESCRIPTION OF DRAWINGS

The accompanying drawings, which are incorporated in and constitute a part of the present application, provide a further understanding of the present application. The exemplary embodiments of the present application and their descriptions are used to explain the present application and do not constitute improper limitations of the present application. The drawings is illustrated as follows:

FIG. 1 is a structural diagram of a fishway with a pool head and a pool tail according to a first embodiment of the present application;

FIG. 2 is a partial top view of the pool head of the fishway with a pool head and a pool tail according to the first embodiment of the present application;

FIG. 3 is a first sectional view of the pool head in FIG. 2;

FIG. 4 is a second sectional view of the pool head in FIG. 2;

FIG. 5 is a first partial three-dimensional structural diagram of the fishway with a pool head and a pool tail according to the first embodiment of the present application;

FIG. 6 is a second partial three-dimensional structural diagram of the fishway with a pool head and a pool tail according to the first embodiment of the present application;

FIG. 7 is a partial structural schematic diagram of an upstream steep-slope fishway in FIG. 6;

FIG. 8 is a structural diagram of the fishway with a pool head and a pool tail according to a second embodiment of the present application;

FIG. 9 is a partial top view of the pool tail of the fishway with a pool head and a pool tail according to the second embodiment of the present application;

FIG. 10 is a curve diagram showing a relationship between poor water depth and fish passage efficiency in a main fishway, obtained through model tests according to a first embodiment of the present application (Note: dimensions shown are model dimensions).

### REFERENCE NUMERALS

100: fishway with a pool head and a pool tail; 10: main fishway; 20: pool head; 211: first branch channel; 212: second branch channel; 22: upstream maintenance gate; 23: first gate; 24: fixed gate; 25: upstream steep-slope fishway; 251: movable gate; 26: fish barrier screen; 27: fish guiding cylinder group; 28: sliding hinge support point; 29: dual-control working gate; 30: pool tail; 311: third branch channel; 312: fourth branch channel; 31: downstream steep-slope fishway; 32: downstream maintenance gate; 33: flow control gate; 34: spoiler cylinder group.

### DETAILED DESCRIPTION OF THE EMBODIMENTS

It should be understood that the specific embodiments described herein are merely used to explain the present application and are not intended to limit the present application.

The technical solutions in the embodiments of the present application will be clearly and completely described below with reference to the accompanying drawings. Obviously, the described embodiments are only a part of the embodiments of the present application, not all of them. All other embodiments obtained by those skilled in the art without creative effort based on the embodiments of the present application shall fall within the protection scope of the present application.

It should be noted that all directional indications (such as up, down, left, right, front, back etc.) in the embodiments of the present application are only used to explain the relative positional relationships and movement conditions between components under a specific posture (as shown in the drawings). If the specific posture changes, these directional indications change accordingly.

Additionally, descriptions involving “first,” “second,” etc. in the present application are only used for descriptive purposes and should not be understood as indicating or implying their relative importance or implicitly indicating the number of technical features. Thus, features limited by “first,” “second” may explicitly or implicitly include at least one such feature. Furthermore, technical solutions between different embodiments can be combined, but only on the basis that they can be realized by those skilled in the art. When the combination of technical solutions appears contradictory or unrealizable, such combination should be considered non-existent and not within the protection scope of the present application.

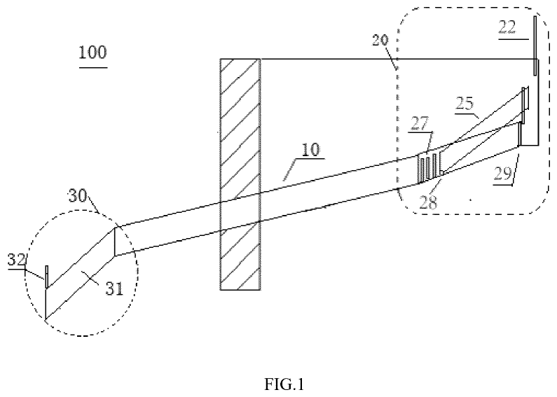

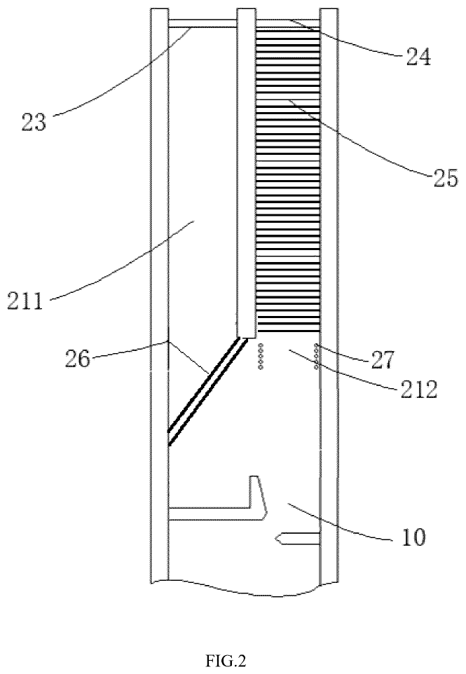

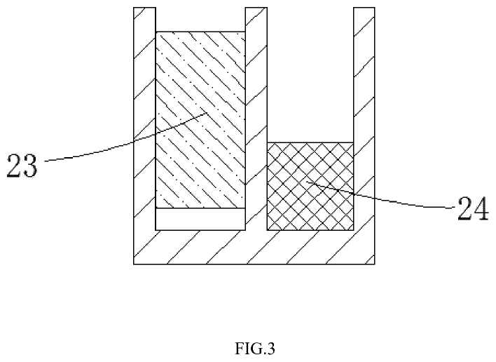

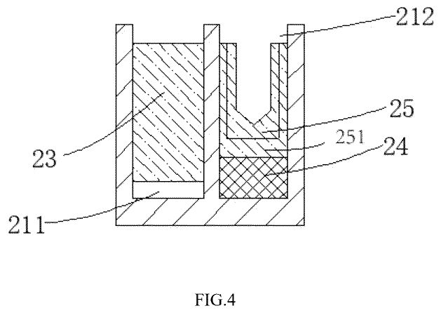

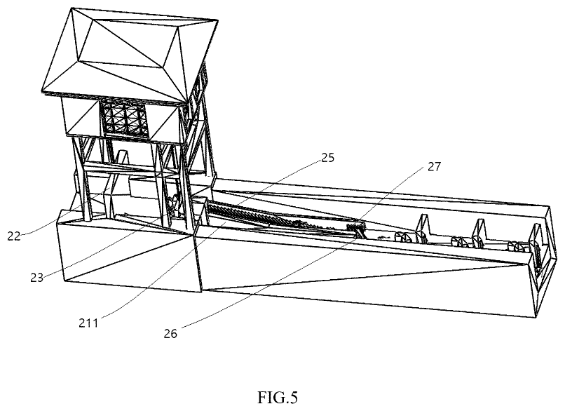

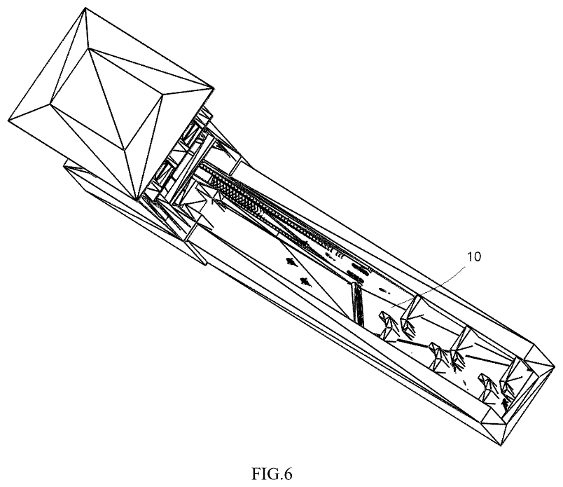

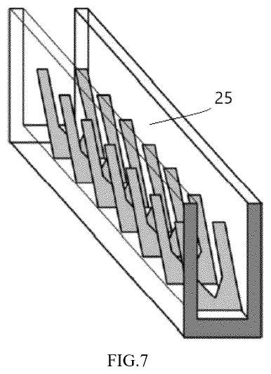

As shown in FIGS. 1, 2, 3, 4, 5, 6, and 7, a first embodiment of the present application provides a fishway 100 with a pool head and a pool tail, and the fishway 100 includes a main fishway 10, a pool head 20 located at an upstream of the water flow of the main fishway 10, and a pool tail 30 located at a downstream of the water flow of the main fishway 10. The pool head 20 and the pool tail 30 are flow channels for water flow and fish to pass through. The pool head 20 is equipped with an upstream maintenance gate 22, and a dual-control working gate 29 (dual control refers to flow control and fish passage effect control) is arranged at a downstream of the upstream maintenance gate 22. A first branch channel 211 and a second branch channel 212 are arranged in a spaced relationship at a downstream of the dual-control working gate 29. The water inlets of the first branch channel 211 and the second branch channel 212 are connected at the downstream of the dual-control working gate 29, and the water outlets of the first branch channel 211 and the second branch channel 212 are respectively connected to the main fishway 10. Please refer to FIGS. 3, 4, 5 and 6, the dual-control working gate 29 includes a first gate 23, a fixed gate 24, and a movable gate 251. The first gate 23 for regulating the flow of the first branch channel 211 is arranged at a water inlet of the first branch channel 211. The fixed gate 24 and the movable gate 251 are arranged at the water inlet of the second branch channel 212. An upstream steep-slope fishway 25 is arranged in the second branch channel 212, and a sliding hinge support point 28 set at a bottom of the upstream steep-slope fishway 25 is supported on a bottom surface of the second branch channel 212. A head portion of the upstream steep-slope fishway 25 is connected to the movable gate 251. The fishway 100 includes a driving mechanism. An upper end of the upstream steep-slope fishway 25 drives the movable gate 251 to lift and position through the driving mechanism, thereby adjusting an inclination angle of the upstream steep-slope fishway 25 in the second branch channel 212 and adjusting the inflow rate of the head portion of the upstream steep-slope fishway 25, while cooperating with the fixed gate 24 to seal a lower portion of the upstream steep-slope fishway 25. The pool tail 30 is equipped with a downstream steep-slope fishway 31, and a head portion of the downstream steep-slope fishway 31 is connected to the main fishway 10, and a downstream maintenance gate 32 is arranged at a tail portion of the downstream steep-slope fishway 31.

By installing the first gate 23 in the pool head 20 to control fishway flow and arranging the upstream steep-slope fishway 25 to ensure fish passage effectiveness, the pool head 20 can adapt to water level variations of the upstream in the hydro-junction (dam), achieving beneficial effects of balancing flow control and ensuring suitable water flow conditions for fish passage. Meanwhile, the water level variation range in a poor of the main fishway 10 will not be too large, maintaining consistency in a longitudinal (along flow direction) dimensions of the poor of the main fishway 10, laying the foundation for standardized fishway construction in the main fishway 10.

It can be understood that in the present application, the pool head 20 is located at the head portion of the fishway upstream of the hydro-junction, which serves as the exit for fish passing upstream through the fishway, and sever as the water inlet of the main fishway 10. The functions of the pool head 20 include adapting to the water level variation range of the upstream of the hydro-junction, providing appropriate flow for the main fishway 10 to ensure that the water depth of the main fishway 10 is within a “optimal operating depth” range; at the same time, the upstream steep-slope fishway 25 is set between the water depth of the pool of the main fishway 10 and the upstream water level to ensure that upstream migrating fish can enter the upstream waters from the main fishway 10 through the upstream steep-slope fishway 25 of the pool head 20.

It can be understood that the first branch channel 211 is used for flow control, while the second branch channel 212, besides controlling flow, primarily provides good fish passage conditions. The movable gate 24 is lifted up and down by the driving mechanism to adjust the water flow into the first channel 211. The upstream steep-slope fishway 25 is set in the second branch channel 212, and a top end of the upstream steep-slope fishway 25 is connected to the movable gate 251, and the movable gate moves vertically through the driving mechanism, simultaneously moving the top end of the upstream steep-slope fishway 25 vertically, adjusting the inflow rate of an upper end of the upstream steep-slope fishway 25, while ensuring fish passage effectiveness. The fixed gate 24 is set in the second branch channel 212 and seals tightly with the movable gate 251.

It can be understood that the main fishway 10 is the most important part of the entire fishway project and can be various types of technical fishways (such as pool-type fishways, nature-like fishways, etc.). The difference between the present application and general fishways is that with a flow control capability of the pool head 20, the water depth in the main fishway 10 can be maintained within an optimal range for fish passage, so the water level variation range in the poor of the fishway will not be too large, allowing the structural form of the main fishway 10 to be fixed and standardized.

It can be understood that the pool tail 30 is located at the end of the downstream fishway of the hydro-junction (dam), and serves as the entrance for fish ascending through the fishway and the outlet for water flow of the main fishway 10. The functions of the pool tail 30 include adapting to downstream water level variations at the hydro-junction without letting these variations affect the operation of the main fishway 10. At the same time, a downstream steep-slope fishway 31 is installed between water level of the pool of the main fishway 10 and the downstream water level, ensuring upstream migrating fish can enter the main fishway 10 through the downstream steep-slope fishway 31 in the pool tail 30. The downstream steep-slope fishway 31 can be either a fixed or movable fishway, and it can also be designed as a single-stage or multi-stage steep-slope fishway. It can be understood that a pool water depth, a length or a width of the downstream steep slope fishway 31 can be set according to the water level of the pool of the main fishway 10 and the downstream water level.

It can be understood that the first branch channel 211 and the second branch channel 212 are separated by channel baffles, and a water inlet of the first branch channel 211 and a water inlet of the second branch channel 212 merge at the head position, and a water outlet of the first branch channel 211 and a water outlet the second branch channel 212 merges with the main fishway 10 at a tail position. The first gate 23 can be a vertical gate. By adjusting a height of the first gate 23, the amount of water flowing through the bottom of the first branch channel 211 can be adjusted. The fixed gate 24 is fixed at the bottom of the second branch channel 212, and the second branch channel 212 is equipped with the movable gate 251. A sliding hinge support point 28 set on a downstream end of the upstream steep-slope fishway 25 is supported on the bottom surface of the second branch channel 212, and an upstream top end of the upstream steep-slope fishway 25 connects to the movable gate 251. A fish passage channel of the upstream steep-slope fishway 25 passes through the movable gate 251. An upstream adjustment driving mechanism drives the movable gate 251 to lift and position, thereby adjusting the inclination angle of the upstream steep-slope fishway 25 in the second branch channel 212 and adjusting the inflow rate at the head position of the upstream steep-slope fishway 25. The channel baffle can be directly inserted between the first branch channel 211 and the second branch channel 212, and sealed with gaskets or sealing rings to isolate the first branch channel 211 from the second branch channel 212.

Furthermore, in one embodiment of the present application, a Denil fishway is used as the steep-slope fishway (upstream steep-slope fishway 25 or downstream steep-slope fishway) to match flow regulation and ensure fish passage effectiveness. The water-passing profile of the upstream steep-slope fishway 25 includes a rectangular opening cross section and a converging opening cross section at a lower portion of the rectangular opening cross section. Besides the Denil fishway, other types of fishways can also be used as steep-slope fishways in the present application.

It can be understood that in the present application, the water-passing profile of the upstream steep-slope fishway or the downstream steep-slope fishway may include the rectangular opening cross section and the converging opening cross section at the lower portion of the rectangular opening cross section, or the water-passing cross sections of the upstream steep slope fishway and the downstream steep slope fishway may both include the rectangular opening cross section and the converging opening cross section at the lower portion of the rectangular opening cross section. In a preferred embodiment, the fishway structures of the downstream steep-slope fishway and the upstream steep-slope fishway are the same.

Furthermore, to guide target fish to smoothly enter into the upstream steep-slope fishway 25, a fish barrier screen 26 is installed at the water outlet of the first branch channel 211. In one specific embodiment, the first branch channel 211 and the second branch channel 212 are separated by the channel baffles. The fish barrier screen 26 is located at the water outlet of the first branch channel 211, and a first end of the fish barrier screen 26 is connected to the channel baffle, and a second end of the fish barrier screen 26 is connected to a side wall of the first branch channel 211, and the fish barrier screen 26 slops downward from the first end toward the second end along the water flow direction. Installing the fish barrier screen 26 at the water outlet of the first branch channel 211 helps guide fish at the water inlet of the main fishway 10 to the second branch channel 212 and ultimately help fish ascend through the upstream steep-slope fishway 25, achieving good fish passage effects.

Furthermore, to improve fish guidance at the fishway inlet of the upstream steep-slope fishway 25, a fish guiding cylinder group 27 are arranged at the water outlet (fishway inlet) of the second branch channel 212. Two groups of the fish guiding cylinder groups 27 are arranged oppositely on both sides of the second branch channel 212, and the fish guiding cylinder group 27 includes a plurality of spoiler columns arranged at intervals along the extending direction of the second branch channel 212, creating flow characteristics that attract fish into the steep-slope fishway. Optionally, the spoiler columns create turbulence at the fishway inlet of the second branch channel 212 to induce fish to ascend, cooperating with the fish barrier screen 26 to guide fish through the fishway inlet of the second branch channel to ascend via the upstream steep-slope fishway 25. The spoiler columns can be either semi-cylindrical or cylindrical piers, made of either concrete or steel tube piers.

Furthermore, to adapt to downstream water level changes, the pool tail 30 is equipped with a downstream steep-slope fishway 31, and a downstream maintenance gate 32 is arranged at a tail end of the downstream steep-slope fishway 31. The downstream steep-slope fishway 31 can be either a fixed fishway or a movable fishway, or can be also a single-stage fishway or a multi-stage fishway. The water inlet of the downstream steep-slope fishway 31 is fixed to the main fishway 10, and the water outlet of the downstream steep-slope fishway 31 connects to a bottom of river. The installation range of the downstream steep-slope fishway 31 should ensure that the downstream water level variations do not affect the main fishway 10. In one embodiment, a fixed single-stage steep-slope fishway is used for the downstream steep-slope fishway 31. Preferably, the downstream maintenance gate 32 is arranged at the tail end of the fishway 100, a function of the downstream maintenance gate 32 is to cut off the connection between the main fishway 10 and the downstream water level when closed, allowing periodic maintenance of the pool tail of the fishway.

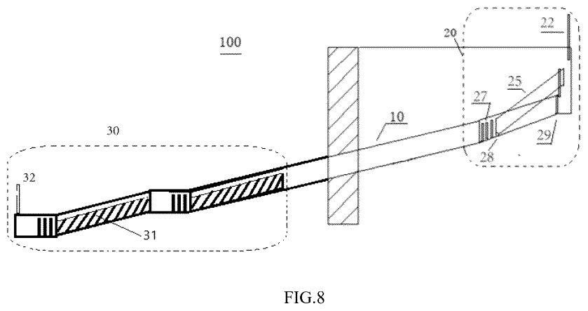

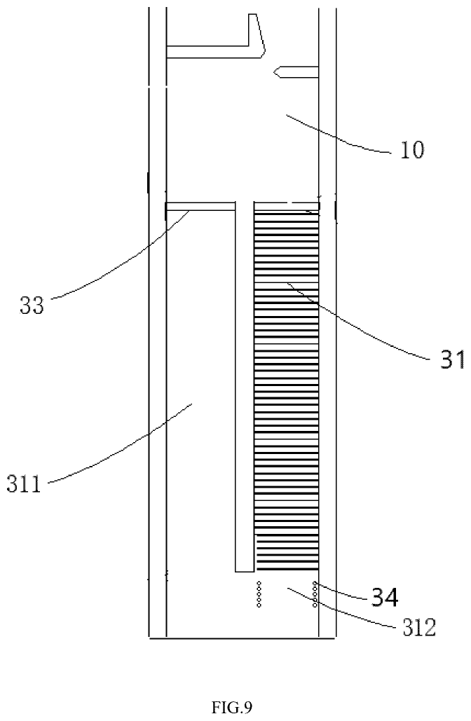

Referring to FIGS. 8 and 9, in a second embodiment of the present application, the pool tail 30 is equipped with a downstream maintenance gate 32, and a third branch channel 311 and a fourth branch channel 312 are arranged at the upstream of the downstream maintenance gate 32. A water inlet of the third branch channel 311 and a water inlet of the fourth branch channel 312 are connected at the main fishway 10, and a water outlet of the third branch channel 311 and a water outlet of the fourth branch channel 312 are connected at the upstream of the downstream maintenance gate 32. A flow control gate 33 for controlling the flow of the third branch channel 311 is arranged at the water inlet of the third branch channel 311, and the downstream steep-slope fishway 31 is arranged inside the fourth branch channel 312. In one specific embodiment, the downstream steep-slope fishway 31 is equipped with a fixed two-stage steep-slope fishway. A spoiler cylinder group 34 is arranged at the water outlet (i.e., the fishway inlet) of the fourth branch channel 312. Two groups of spoiler cylinder groups 34 are relatively arranged on both sides of the fourth branch channel 312. The spoiler cylinder group 34 includes a plurality of spoiler columns arranged at intervals along the extension direction of the fourth branch channel 312, so as to form flow characteristics that can lure fish to swim upstream of the downstream steep-slope fishway 31, thereby improving the fish passing efficiency.

It can be understood that fish complete their migration by swimming upstream. In the scheme of the present application, the water inlet of the main fishway 10 is the fishway outlet of the main fishway 10, and the water outlet of the main fishway 10 is the fishway inlet of the main fishway 10; the water inlet of the second branch channel 212 is the fishway inlet of the second branch channel 212, and the water outlet of the second branch channel 212 is the fishway inlet of the second branch channel 212; the water inlet of the fourth branch channel 312 is the fishway outlet of the fourth branch channel 312, and the water outlet of the fourth branch channel 312 is the fishway inlet of the fourth branch channel 312.

It can be understood that in other embodiments, the upstream adjustment driving mechanism and a downstream adjustment driving mechanism can also be hoisting positioning structures, which adjust installation inclination angles of the upstream steep-slope fishway 25 and downstream steep-slope fishway 31 through the hoisting positioning structures. The upstream adjustment driving mechanism and the downstream adjustment driving mechanism can also be lifting positioning structures.

Referring to FIGS. 1 and 9, the present application provides two specific embodiments. In the first embodiment, the pol tail is a single-stage steep slope fishway. In the second embodiment, the pool tail is composed of two branch channels, one of which has a single-stage steep slope fishway inside, and the overall structure of the pool tail is a double-stage steep slope fishway or a multi-stage steep slope fishway. In the second embodiment, the pool head and the pool tail are further adapted to the upstream and downstream water level fluctuations, so that the main fishway 10 is no longer affected by water level changes.

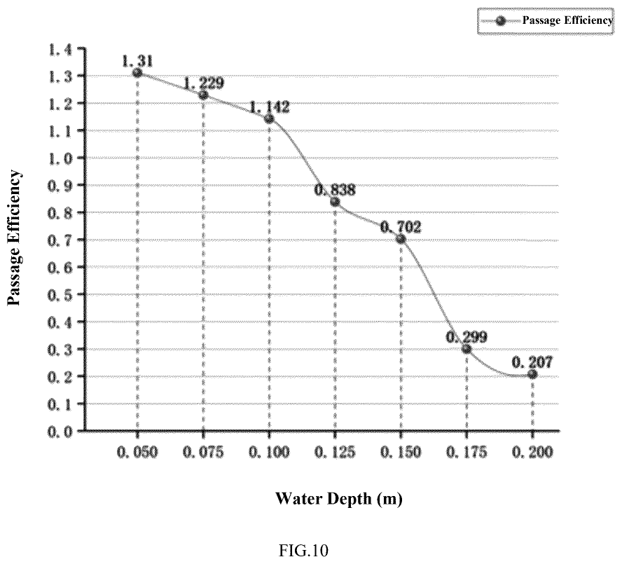

Referring to FIG. 10, the present application also provides a method for guiding fish, including the following steps: determining the optimal fish-passage water depth range for target fish; adjusting the inflow rate of the first branch channel 211 and the upstream steep-slope fishway 25 according to the upstream water level to maintain a fish-passage water depth of the main fishway 10 and the upstream steep-slope fishway 25 within the optimal fish-passage water depth range.

The above are only preferred embodiments of the present application and are not intended to limit the present application. For those skilled in the art, the present application can have various changes and variations. Any modifications, equivalent replacements, improvements, etc., made within the spirit and principles of the present application should be included within the protection scope of the present application.

What is claimed is:

1. A fishway with a pool head and a pool tail, wherein the fishway comprises a main fishway, a pool head located at an upstream of water flow of the main fishway, and a pool tail located at a downstream of the water flow of the main fishway,
wherein the pool head is equipped with an upstream maintenance gate, and a dual-control working gate is arranged at a downstream of the upstream maintenance gate, a first branch channel and a second branch channel are arranged separately below the dual-control working gate, a water inlet of the first branch channel and a water inlet of the second branch channel are connected at a downstream of the dual-control working gate, and a water outlet of the first branch channel and a water outlet of the second branch channel are respectively connected to the main fishway,
wherein the dual-control working gate comprises a first gate, a fixed gate and a movable gate, the first gate for regulating flow of the first branch channel is arranged at a water inlet of the first branch channel, the fixed gate and the movable gate are arranged at a water inlet of the second branch channel, an upstream steep-slope fishway is arranged in the second branch channel, a sliding hinge support point at a bottom of the upstream steep-slope fishway is supported on a bottom surface of the second branch channel, a head portion of the upstream steep-slope fishway is connected to the movable gate, and the dual-control working gate further comprises a driving mechanism, an upper end of the upstream steep-slope fishway drives the movable gate to lift and position through the driving mechanism, thereby adjusting an inclination angle of the upstream steep-slope fishway in the second branch channel and adjusting an inflow rate of the head portion of the upstream steep-slope fishway, while cooperating with the fixed gate to seal a lower portion of the upstream steep-slope fishway,
wherein the pool tail comprises a downstream steep-slope fishway, and a downstream maintenance gate is arranged at a tail portion of the downstream steep-slope fishway.

2. The fishway with a pool head and a pool tail according to claim 1, wherein the downstream maintenance gate is arranged in the pool tail, a third branch channel and a fourth branch channel are arranged at an upstream of the downstream maintenance gate, a water inlet of the third branch channel and a water inlet of the fourth branch channel are connected at the main fishway, and a water outlet of the third branch channel and a water outlet of the fourth branch channel are connected with the upstream of the downstream maintenance gate,
a flow control gate for controlling flow of the third branch channel is arranged at the water inlet of the third branch channel, and the downstream steep-slope fishway is arranged in the fourth branch channel.

3. The fishway with a pool head and a pool tail according to claim 2, wherein a water-passing profile of the upstream steep-slope fishway comprises a rectangular opening cross section and a converging opening section located at a lower portion of the rectangular opening cross section.

4. The fishway with a pool head and a pool tail according to claim 1, wherein a fish barrier screen is installed at the water outlet of the first branch channel.

5. The fishway with a pool head and a pool tail according to claim 1, wherein,
a fish guiding cylinder group is arranged at a fishway inlet of the second branch channel, and two groups of the fish guiding cylinder groups are arranged oppositely on both sides of the second branch channel, and the fish guiding cylinder group comprises a plurality of spoiler columns arranged at intervals along an extending direction of the second branch channel;
the sliding hinge support point at the bottom of the upstream steep-slope fishway falls on the bottom surface of the second branch channel, and a hinge support axis of the upstream steep-slope fishway is located at an upstream of the fish guiding cylinder group.

6. The fishway with a pool head and a pool tail according to claim 2, wherein a fish barrier screen is installed at the water outlet of the first branch channel.

7. The fishway with a pool head and a pool tail according to claim 2, wherein,
a fish guiding cylinder group is arranged at a fishway inlet of the second branch channel, and two groups of the fish guiding cylinder groups are arranged oppositely on both sides of the second branch channel, and the fish guiding cylinder group comprises a plurality of spoiler columns arranged at intervals along an extending direction of the second branch channel;
the sliding hinge support point at the bottom of the upstream steep-slope fishway falls on the bottom surface of the second branch channel, and a hinge support axis of the upstream steep-slope fishway is located at an upstream of the fish guiding cylinder group.
